(19) United States
(12) Patent Application Publication
(10) Pub. No.: US 2020/0393073 A1
(43) Pub. Date: Dec. 17, 2020

(54) COMPENSATOR WITH BACKUP ASSEMBLY AND CORRESPONDING METHOD

(71) Applicant: FIVES NORDON, NANCY (FR)

(72) Inventors: Etienne CARLU, NANCY (FR); Olivier GRADOT, NANCY (FR)

(21) Appl. No.: 16/971,024

(22) PCT Filed: Feb. 18, 2019
(86) PCT No.: PCT/EP2019/053917

§ 371 Date: Aug. 19, 2020

(30) Foreign Application Priority Data
Feb. 19, 2018 (FR) 18 51374

(51) Int. Cl. F16L 51/02; F16L 51/03

(52) U.S. Cl. CPC F16L 51/025; F16L 27/11; F16L 51/03

(57) ABSTRACT

A compensator (100) comprising an upstream sleeve (30) configured for being connected in a sealed manner to an upstream pipe (2), a downstream sleeve (31) configured for being connected in a sealed manner to a downstream pipe (3), and a bellows (1) connecting, in a sealed manner, the upstream sleeve and the downstream sleeve. The compensator (100) further comprises a backup assembly (4) comprising a backup bellows (5), the backup assembly being suitable for switching from a rest state, in which the backup assembly is not sealingly connected to at least one of the upstream sleeve and the downstream sleeve, to an operating state, in which the backup assembly is sealingly connected to the upstream sleeve and to the downstream sleeve.

The invention relates to the field of expansion compensators, also called expansion joints. It more particularly relates to compensators mounted on installations whose operating stresses make it difficult to deposit compensators for the replacement thereof.

Expansion compensators connect an upstream piping to a downstream piping. They make it possible to compensate, between their upstream side and their downstream side, the relative movements of two piping segments, and/or equipment items that are associated with them. They also make it possible to ensure continuity of the sealed enclosure of the network, which can be at atmospheric pressure, under pressure or under vacuum.

The relative movements to be compensated can be axial (in the axis of the compensator), lateral (perpendicular to the axis of the compensator), angular, or a combination of these movements.

The compensators include an element absorbing, by elongation or compression, the relative movements described above. This absorbent element can for example be made up of a resilient membrane or a bellows. A bellows makes it possible to compensate a significant movement by limiting the axial space requirement of the compensator. In the case of industrial pipings, the bellows are most often made from metal alloys, for reasons related to the operating conditions, in particular the pressure and the temperature of the transported fluid. In the remainder of this document, for convenience, we will use the term “bellows” to refer to any element absorbing the movement between the upstream and downstream pipes, this term not further limiting the scope of the claims.

During use, following damage due to fatigue, corrosion, erosion or thermal aging, for example, leaks may appear on the bellows or on the adjacent welds and couplings.

Preventive solutions exist. Thus, U.S. Pat. No. 3,472,062 describes a solution that consists of using multilayer bellows. The multiple layers make up a single bellows and deform together when the bellows is deformed. In the case of a leak of one of the walls, the non-leaking wall(s) provide the resistance and sealing of the component.

Curative solutions are possible. Localized repairs of welds or changes of bellows can be done. Without completely disassembling apparatuses, a new bellows is necessarily added by reconstituting the latter by on-site welding from sectors of a bellows previously formed, then cut into sectors. This method has different drawbacks, the most significant of which are decreased fatigue behavior, which cannot be predicted by calculation, and a substantial implementation time. The stipulations of the codes and standards in terms of geometry of the weld beads are difficult to respect or keep due to the difficulties caused during the assembly by welding of the preformed sectors. It is also very difficult to perform the radiographic or ultrasound volume inspections that are stipulated by the regulations on the longitudinal welds between sectors. U.S. Pat. No. 3,927,818 describes a method for reconstituting bellows from sectors welded on site.

One aim of the present invention is to address these problems in whole or in part.

To that end, the invention relates to a compensator comprising:

an upstream sleeve configured for being connected in a sealed manner to an upstream pipe,

a downstream sleeve configured for being connected in a sealed manner to a downstream pipe, and

a bellows connecting, in a sealed manner, the upstream sleeve and the downstream sleeve,

wherein the compensator further comprises a backup assembly comprising a backup bellows, the backup assembly being suitable for switching from a rest state, in which the backup assembly is not sealingly connected to at least one of the upstream sleeve and the downstream sleeve, to an operating state, in which the backup assembly is sealingly connected to the upstream sleeve and to the downstream sleeve.

According to specific embodiments, the compensator comprises one or several of the following features, considered alone or according to any technically possible combinations:

the backup assembly is suitable for going from the rest state to the operating state after a maintenance operation done in situ, during which the upstream sleeve and the downstream sleeve are intended to remain sealingly connected respectively to the upstream pipe and to the downstream pipe;

in the rest state, the backup assembly is sealingly connected to any single one of the upstream sleeve and the downstream sleeve;

between the rest state and the operating state of the backup assembly, the backup bellows occupies two separate positions relative to the upstream sleeve and the downstream sleeve;

the backup bellows is suitable for experiencing a plastic deformation by extension during the passage of the backup assembly from the rest state to the operating state;

the compensator further comprises at least one connection point making it possible to connect one or several mechanical devices to the compensator, the mechanical devices being intended to perform the plastic deformation of the backup bellows;

the connection point is positioned on the backup bellows;

the backup assembly comprises at least one moving element, the moving element being movable between a first position relative to the upstream and downstream sleeves in the rest state, and a second position, occupied in the operating state and in which the moving element connects the upstream sleeve and the downstream sleeve;

the moving element is telescopic;

the compensator comprises at least one device suitable for circulating a gas in a volume located between the bellows and the backup assembly, the circulation of the gas being intended to be done during the passage from the rest state to the operating state; and

the compensator comprises a device suitable for performing a sealing test in a volume located between the bellows and the backup assembly, the sealing test being intended to be done after going from the rest state to the operating state.

The invention also relates to a maintenance method for maintaining a compensator as described above, comprising at least one operation for connecting the backup assembly in a sealed manner to the upstream sleeve and to the downstream sleeve, the operation being done in situ without disconnecting the upstream sleeve and the downstream sleeve respectively from the upstream pipe and the downstream pipe.

According to specific embodiments, the method includes one or more of the following features, considered alone or according to any technically possible combination(s):

the backup bellows is placed instead and in place of the bellows after the latter is deposited;

the second bellows is plastically deformed by extension during the passage of the backup assembly from the rest state to the operating state in order to connect the backup assembly sealingly to the upstream sleeve and to the downstream sleeve; and

a gas circulates in a volume located between the bellows and the backup assembly during the passage from the rest state to the operating state and/or next, in order to perform one or several of the following functions: purging of the volume, discharge of dangerous gases that may be found in the volume, inerting of the volume, limitation of the intake of process fluid in the volume, and cooling parts delimiting the volume, the parts being able to heat up during the passage from the rest state to the operating state.

Thus, the compensators are provided with a backup bellows preinstalled on the apparatus. This bellows is preserved from the usage conditions before potentially being commissioned in case of leak of the bellows having been commissioned first. These backup bellows are thus in new condition when they are commissioned. “New” means that the backup bellows will not have worked in fatigue and will not be subject to the temperature (absence of thermal aging of the component alloy of the bellows), or to the pressure, or to the physicochemical impacts (corrosion, adsorption-absorption and diffusion of harmful chemical species) related to the contact with the operating fluid. The backup bellows, like the initial bellows, can have multiple layers.

Thus, the backup bellows is kept and connected later if needed, for example after detection of a leak of the main bellows or after a determined period, for preventive maintenance. Their connection makes it possible to cover, or keep, the sealing of the pipe.

This backup bellows provides multiple improvements. It in particular makes it possible to extend the fatigue lifetime of the compensator, since the backup bellows is not subject to fatigue and/or thermal aging before it is commissioned, unlike the multilayer systems with a single bellows. Furthermore, the backup bellows has a verified and regulated morphology and weld bead compactness according to the stipulations of the main codes and standards of construction.

The invention optionally comprises a certain number of other features that will be more explicitly discussed hereinafter regarding exemplary embodiments described in reference to the appended drawings, but which are in no way limiting.

The invention will be better understood upon reading the following description, provided solely as an example, and done in reference to the appended drawings.

A compensator according to the invention is described therein, which is for example cylindrical with a circular section. Thus, only a half-sectional view is shown in the figures.

Nevertheless, according to variants that are not shown, compensators according to the invention can have other forms, and for example have a square or rectangular section.

In the appended drawings:

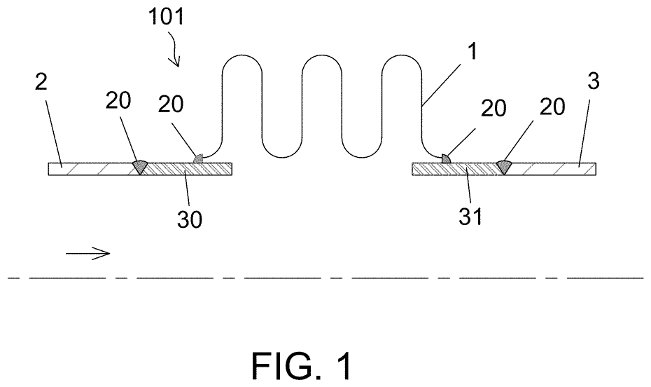

FIG. 1 is a schematic illustration of a compensator according to the state of the art;

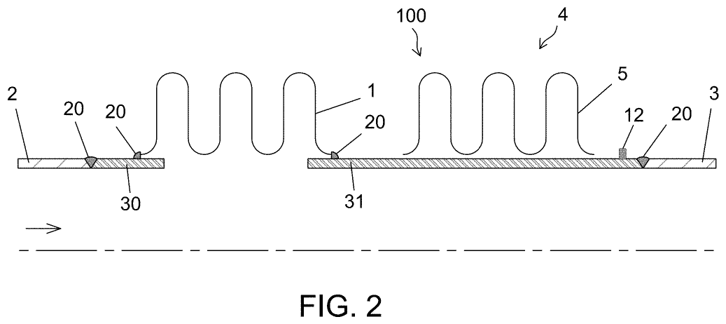

FIG. 2 is a schematic illustration of a first exemplary embodiment of a compensator according to the invention, in which the backup assembly is shown in its so-called rest state;

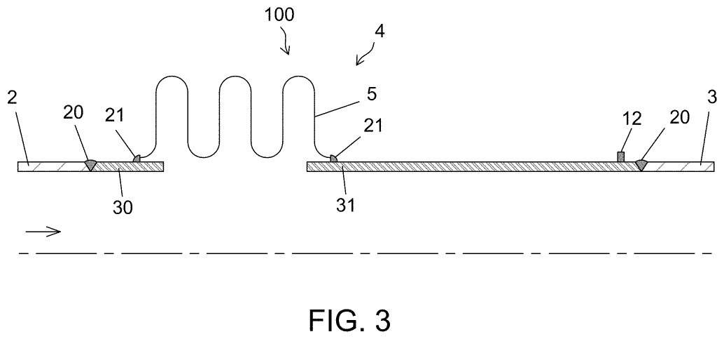

FIG. 3 is an illustration of the compensator of FIG. 2, with the backup assembly placed in its so-called operating state;

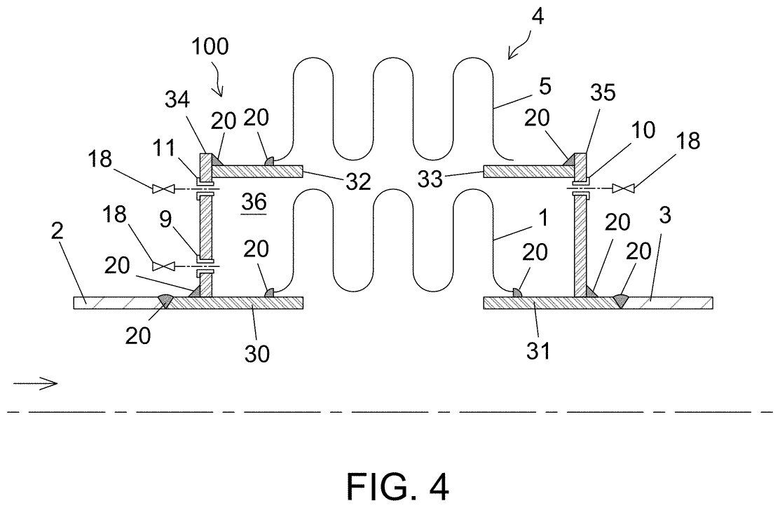

FIG. 4 is a schematic illustration of a second exemplary embodiment of a compensator according to the invention, in which the backup assembly is shown in its so-called rest state;

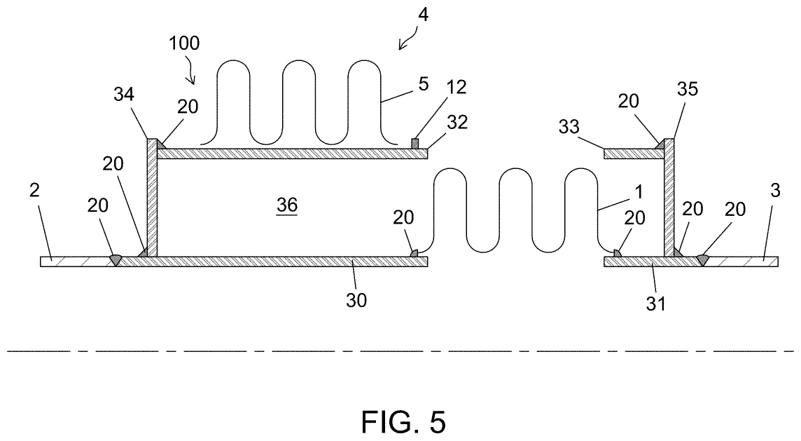

FIG. 5 is a schematic illustration of a third exemplary embodiment of a compensator according to the invention, in which the backup assembly is shown in its so-called rest state;

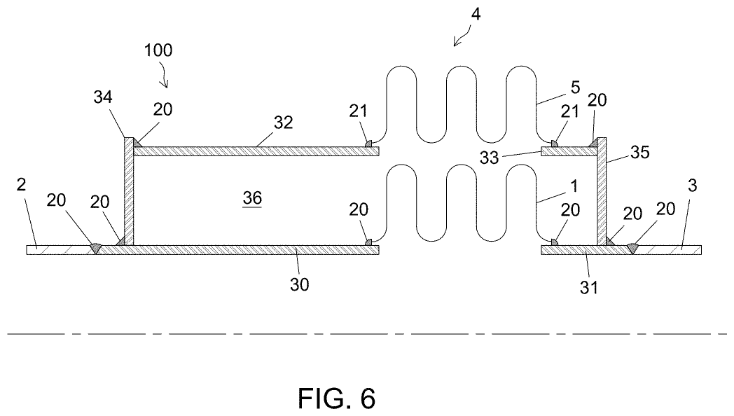

FIG. 6 is a schematic illustration of the compensator of FIG. 5, with the backup assembly placed in its so-called operating state;

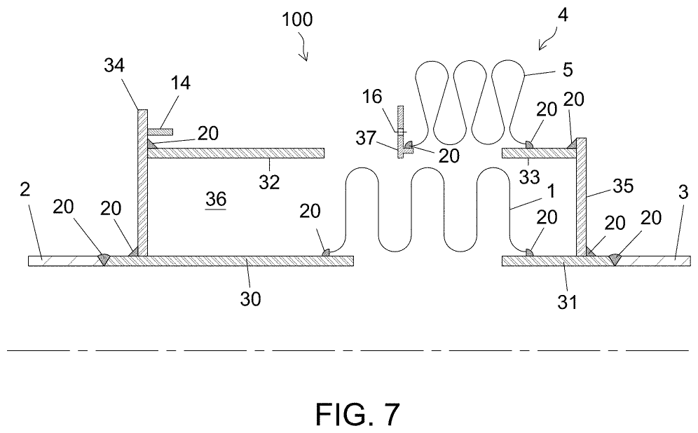

FIG. 7 is a schematic illustration of a fourth exemplary embodiment of a compensator according to the invention, in which the backup assembly is shown in its so-called rest state;

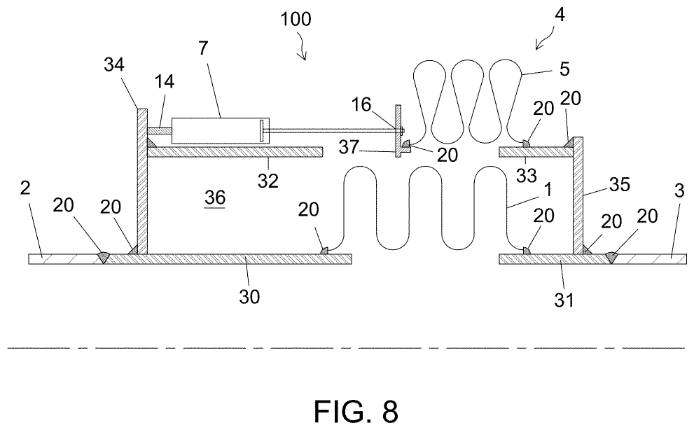

FIG. 8 is a schematic illustration of the compensator of FIG. 7, after placing a traction means making it possible to plastically deform a backup bellows;

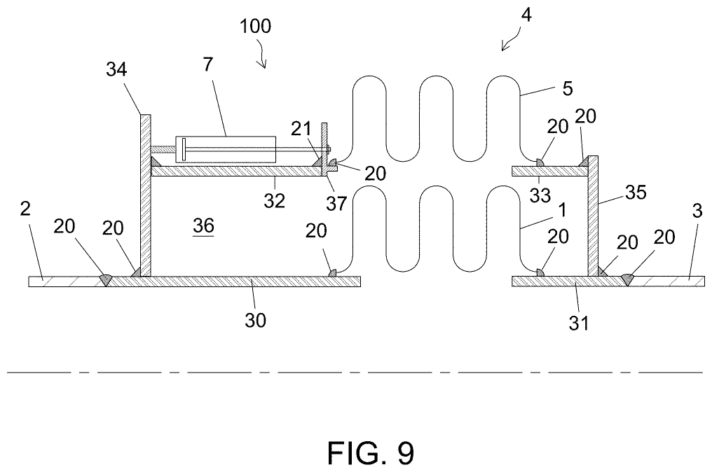

FIG. 9 is a schematic illustration of the compensator of FIGS. 7 and 8, with the backup assembly placed in its so-called operating state;

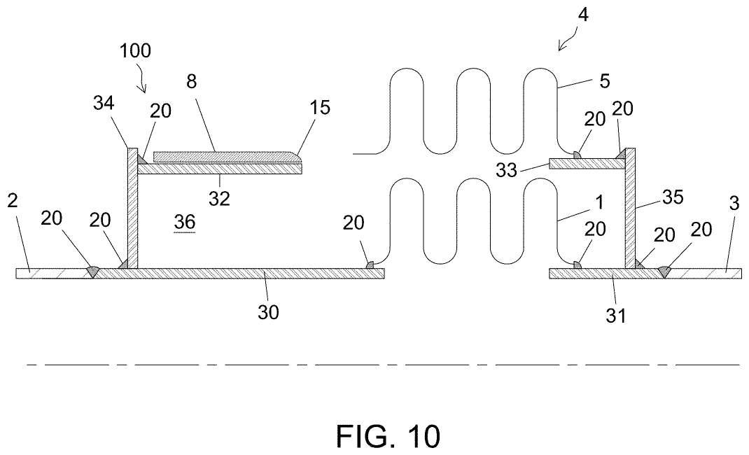

FIG. 10 is a schematic illustration of a fifth exemplary embodiment of a compensator according to the invention, in which the backup assembly is shown in its so-called rest state;

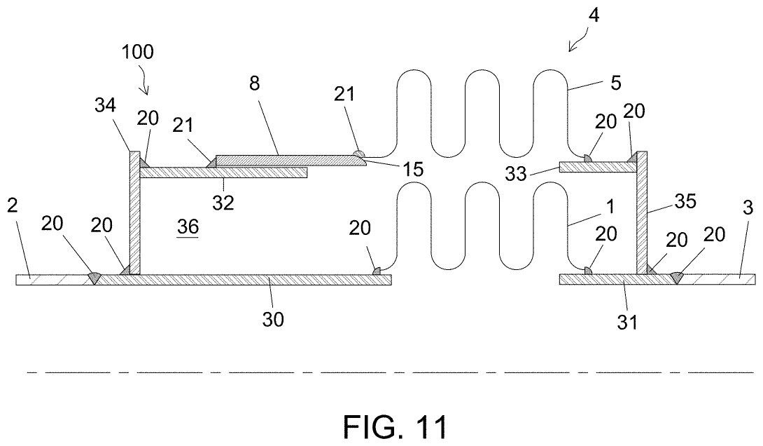

FIG. 11 is a schematic illustration of the compensator of FIG. 10, with the backup assembly placed in its so-called operating state;

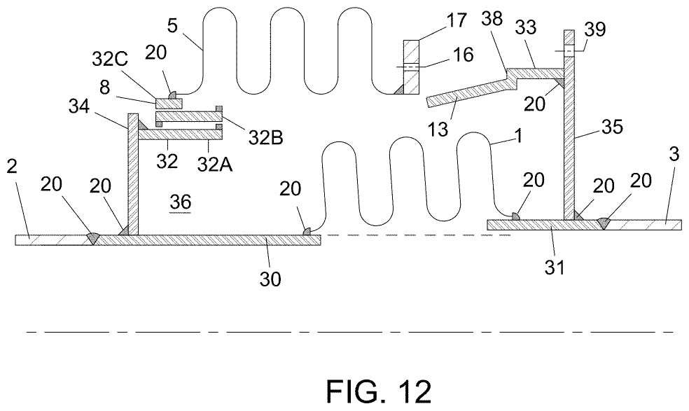

FIG. 12 is a schematic illustration of a sixth exemplary embodiment of a compensator according to the invention, in which the backup assembly is shown in its so-called rest state; and

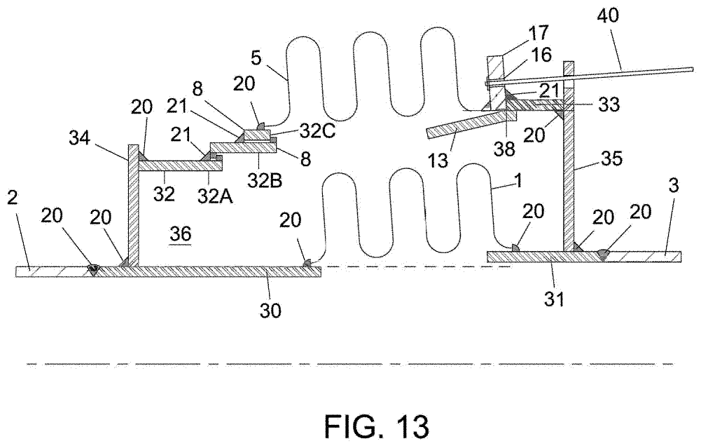

FIG. 13 is a schematic illustration of the compensator of FIG. 12, with the backup assembly placed in its so-called operating state.

The diagram of FIG. 1 schematically shows an exemplary compensator according to the state of the art. The compensator 101 is made up of an upstream sleeve 30 connected to an upstream pipe 2 using a sealed weld 20, a downstream sleeve 31 connected to a downstream pipe 3 using another sealed weld 20, and a bellows 1 with three convolutions connected on its upstream end to the upstream sleeve 30 using a first sealed weld 20 and on its downstream end to the downstream sleeve 31 using a second sealed weld 20. This compensator is suitable for compensating primarily axial relative movements between the upstream and downstream pipes 2, 3, but it can be adapted for other types of movements.

FIG. 2 schematically shows a compensator 100 according to a first exemplary embodiment of the invention.

The compensator 100 comprises an upstream sleeve 30 connected to an upstream pipe 2 using a sealed weld 20, a downstream sleeve 31 connected to a downstream pipe 3 using another sealed weld 20, and a bellows 1 with three convolutions connected on its upstream end to the upstream sleeve 30 using a first sealed weld 20 and on its downstream end to the downstream sleeve 31 using a second sealed weld 20.

The downstream sleeve 31 is longer than according to the state of the art shown in FIG. 1 so as to receive a backup bellows 5.

The downstream sleeve 31 also comprises a stop 12 making it possible to keep the backup bellows 5 in position on the compensator 100 by blocking its longitudinal movement toward the stop 12.

In this example, the backup bellows 5 constitutes the backup assembly 4 as previously described. This backup assembly 4 is shown here in its so-called rest state. Neither of the two ends of the backup bellows 5 is connected to the upstream sleeve 30 or to the downstream sleeve 31 of the compensator 100.

If a leak is detected at the original bellows 1, the latter is removed. The assembly of the backup bellows 5 can also be done when there is no failure, preventively, for example after the bellows has reached a predefined number of deformation cycles, for example at about 90% of a number of deformation cycles guaranteed by the calculation.

This operation for example consists of dividing the bellows 1 in situ into two pieces by two diametrically opposite longitudinal cuts, for example using an angle grinder, then grinding the welds at the ends of the bellows. Once the bellows 1 has been removed, the backup bellows 5 is moved axially instead and in place of the bellows 1 initially present and welded to the upstream sleeve 30 and to the downstream sleeve 31 using sealed welds 21, as shown in FIG. 3. The backup bellows 5 is then in its so-called operating state.

The backup assembly 4 is suitable for going from the rest state to the operating state through a maintenance operation done in situ, during which the upstream sleeve 30 and the downstream sleeve 31 are intended to stay connected in a sealed manner respectively to the upstream pipe 2 and to the downstream pipe 3.

“In situ” for example means that the maintenance operation is done while the compensator 100 is installed, that is to say sealingly connected respectively to the upstream pipe 2 and the downstream pipe 3.

This first example requires depositing the bellows 1 before commissioning the backup bellows 5. To that end, it is necessary to stop the circulation of the fluid inside the pipes 2, 3.

Conversely, the other examples described hereinafter allow the placement of the backup bellows without stopping the circulation of the fluid, which can be particularly advantageous.

FIG. 4 schematically shows a compensator 100 according to a second exemplary embodiment of the invention.

This compensator 100 comprises an upstream sleeve 30 connected to an upstream pipe 2 using a sealed weld 20, a downstream sleeve 31 connected to a downstream pipe 3 using another sealed weld 20, and a bellows 1 with three convolutions connected on its upstream end to the upstream sleeve 30 using a first sealed weld 20 and on its downstream end to the downstream sleeve 31 using a second sealed weld 20.

A backup bellows 5 is located around the bellows 1 that is initially present. The backup bellows 5 can be installed around or inside fasteners of the compensator (hinges, arms, ring, for example). The backup bellows 5 here is shown welded on its upstream end on an upstream shroud 32 by a sealed weld 20 such that a single sealed weld is made in situ, at its downstream end on a downstream shroud 33.

The upstream 32 and downstream 33 shrouds are sealingly welded on upstream 34 and downstream 35 rings, which are in turn sealingly welded on the upstream 30 and downstream 31 sleeves.

The backup bellows 5, the two upstream and downstream shrouds 32, 33 and the two upstream and downstream rings 34, 35 in this example constitute the backup assembly 4 as previously described. This backup assembly 4 is shown here in its so-called rest state. It will enter its so-called operating state after the welding of the downstream end of the backup bellows 5 on the downstream shroud 35 has been done in situ.

The backup assembly 4 delimits a volume 36 around the bellows 1.

At least one connection 9 equipped with an isolation valve 18 makes it possible to supply this volume 36 with a flushing fluid (not shown), for example air or a neutral gas. This connection 9 is shown in FIG. 4 at the upstream ring 34, but it can of course be located elsewhere, for example on one of the shrouds 32, 33. One or several connections 10 equipped with an isolation valve 18 can also be present in order to discharge all or part of the flushing fluid. This connection 10 is shown in FIG. 4 at the downstream ring 35, but it can of course be located elsewhere, for example on one of the shrouds 32, 33.

The flushing fluid can circulate continuously, when the backup assembly 4 is in its rest state, so as for example to prevent deposits inside the volume 36, for example dust, or the accumulation of a dangerous fluid in this volume, for example a process fluid circulating in the pipe 2, 3 after a leak of the bellows 1. This flushing fluid can also be sent periodically to purge or inert the volume 36 before welding the downstream end of the backup bellows 5 on the downstream shroud 33.

This flushing fluid circulating in the volume 36 can thus make it possible to:

purge this volume located between the bellows 1 and the assembly 4,

discharge hazardous gases that may be located in this volume,

inert this volume by injecting an inert gas,

avoid or decrease the arrival of process fluid in this volume, particularly in case of leak of the bellows 1, and/or

cool the backup bellows 5, the two upstream and downstream shrouds 32, 33 and the two upstream and downstream rings 34, 35, which can heat up during the performed operation to sealingly connect the assembly 4 to the two upstream 2 and downstream 3 pipes.

At least one connection 11, equipped with an isolation valve 18, can also be provided to allow a sealing test of the volume 36 after the operation done on site to sealingly connect the two upstream 2 and downstream 3 pipes. The sealing test can for example comprise sending a gas containing helium into the volume 36 through the connection 11, then looking for the presence of helium around the compensator through an appropriate probe.

A thermal insulator, not shown, can be placed in the volume 36 in order to protect the backup bellows 5 from the heat coming from the fluid circulating in the compensator. A thermal insulator, and/or a mechanical screen, can also be placed outside the backup bellows 5 in order to protect the latter from the environment outside the compensator.

Likewise, a protection fluid can be injected into the volume 36 in order to prevent or decrease the arrival of process fluid in said volume. The flow rate of the protection fluid can be confined to a fixed or controlled pressure value, with a setpoint pressure higher than the pressure of the fluid passing through the compensator.

FIG. 5 schematically shows a compensator 100 according to a third exemplary embodiment of the invention close to the preceding one.

In this example, the backup bellows 5 occupies a withdrawn position in its so-called rest state allowing in situ access to the bellows 1 initially present.

This configuration thus allows easy visual monitoring of the state of the bellows 1. To that end, a device intended to facilitate indirect visual monitoring during use of the bellows can initially be installed on the compensator. It can for example involve guides making it possible to place a video camera or any other means allowing indirect visual inspection or any other nondestructive inspection.

A stop 12 makes it possible to keep the backup bellows 5 in its withdrawn position. To place the backup bellows 5 in its operating state, the stop 12 is removed, then the backup bellows 5 is moved to cover the opening located around the bellows 1 initially present, before being welded sealingly to the two upstream 32 and downstream 33 shrouds, as shown in FIG. 6.

FIG. 7 schematically shows a compensator 100 according to a fourth exemplary embodiment of the invention.

In this example, the backup bellows 5 is deformed in situ during its transition from its rest state to its operating state. This configuration makes it possible to limit the space requirement of the backup bellows 5 in its rest state. This in particular makes it possible to leave an opening for a visual inspection of the bellows 1.

In its rest state, the backup bellows 5 is sealingly welded to one of the shrouds 32 or 33, here the downstream shroud 33. The upstream end of the backup bellows 5 is sealingly welded on a ring 37 equipped with at least one attachment point 16 and more advantageously four or eight attachment points 16 distributed on the circumference of the ring 37. On the side of the upstream ring 34 of the backup assembly 4, one attachment point 14 is placed opposite each attachment point 16 of the backup bellows.

As shown in FIG. 8, the backup bellows 5 is deformed longitudinally by at least one traction means 7, here a jack, connected between an attachment point 14 on the upstream ring 34 and an attachment point 16 on the upstream end of the backup bellows. Advantageously, several traction means 7 distributed on the circumference of the bellows are used to deform the backup bellows. The deformation of the backup bellows 5 is for example plastic, resilient, or partially plastic and partially resilient.

The traction means 7 can be jacking or traction systems, for example. These devices can be passive or active. In case of active devices of the jack type, or a device using a pressurized fluid, the pressure of the pipe can be used as driving force for the active device(s), if the nature of the fluid and the pressure level lend themselves to it.

As shown in FIG. 9, the backup bellows 5 is plastically deformed until the ring 37 of the upstream end of the backup bellows comes into contact with the shroud 32 of the backup assembly 4. A sealed weld 21 is then made between the shroud 32 and the ring 37. Once this weld is made, the backup assembly 4 is in its so-called operating state. The traction device 7 can then be removed.

FIG. 10 schematically shows a compensator 100 according to a fifth exemplary embodiment of the invention.

In this example, a moving element 8, in the form of a shroud, provides the connection between the backup bellows 5 and the shroud 32 of the backup assembly 4. This moving shroud 8 in particular makes it possible to leave an opening for a visual inspection of the bellows 1. The downstream end 15 of the moving shroud 8 located toward the backup bellows 5 for example has an inclined profile facilitating a radial adjustment of the relative position between the backup shroud 5 and the moving shroud.

As shown in FIG. 11, the moving shroud 8 is slid axially in situ until it comes into contact with the backup bellows 5 in order to take the latter from its rest state to its operating state. A first sealed weld 21 is then made between the moving shroud 8 and the backup bellows 5, and a second sealed weld 21 is made at the other end of the moving shroud, between the latter and the shroud 32 of the backup assembly 4. Once these two welds are made, the backup assembly 4 is in its so-called operating state.

FIG. 12 schematically shows a compensator 100 according to a sixth exemplary embodiment of the invention.

A device making it possible to facilitate the on-site approach of the elements to be assembled can be installed on the compensator or in its immediate vicinity. It can for example be a linear guide rail, or a conical part 13 as shown in FIG. 12. These elements are particularly recommended when the upstream and downstream pipes are not aligned during the repair. It is then necessary to deform the compensator to allow an approach of the elements to be assembled. These guides make it possible to correct an angle deviation, a lateral or axial displacement for example.

In this example of FIG. 12, the upstream shroud 32 of the backup assembly 4 is telescopic. It is for example made up of three superimposed shrouds 32A, 32B, 32C.

The shroud 32A is fixed and sealingly welded to the upstream ring 34 of the backup assembly 4.

The shrouds 32B and 32C make up a moving element 8. They move longitudinally to make it possible to close the volume 36 during the passage of the backup assembly 4 from its rest state to its operating state.

The upstream end of the backup bellows 5 is connected by a sealed weld to the movable outer shroud 32C. Its downstream end comprises a ring 17 equipped with at least one connection point 16.

As shown in FIG. 13, when one wishes to take the backup assembly 4 from its rest state to its operating state in situ, a traction means 40 is then connected to an attachment point 16 on the ring 17, here by passing through an orifice 39 placed on the downstream ring 35. Advantageously, several traction means 14, connected to attachment points 16 distributed on the circumference of the backup bellows 5, are used to bring the backup assembly 4 to its operating position.

The downstream shroud 33 comprises an inclined part 13 making it possible to guide the ring 17 to a shoulder 38. This configuration is in particular advantageous when the upstream pipe and the downstream pipe are off-centered relative to one another and the compensator 100 performs a significant lateral compensation. This leads to an incline of the backup bellows 5 of four degrees F. in the example shown in FIG. 13.

Once the ring 17 abuts on the shoulder 38, sealed welds 21 are made between the ring 17 and the downstream shroud 33, and between the upstream shrouds 32A, 32B, 32C. Once these welds are made, the traction means 40 can be removed.

In the exemplary embodiments of the invention shown here, the sealed connections of the compensator 100 with the upstream 2 and downstream 3 pipes are made by welding. They can of course be made by any other means known in itself by one skilled in the art, for example by a standard flange system, a special flange system, or by a flanging system completed by a sealing weld.

Owing to their features, all of the exemplary embodiments of the invention described above at least partially address the problems mentioned the beginning of this document.

1. A compensator comprising:
an upstream sleeve configured for being connected in a sealed manner to an upstream pipe,
a downstream sleeve configured for being connected in a sealed manner to a downstream pipe,
a bellows connecting, in a sealed manner, the upstream sleeve and the downstream sleeve,
wherein the compensator further comprises a backup assembly comprising a backup bellows, the backup assembly being suitable for switching from a rest state, in which the backup assembly is not sealingly connected to at least one of the upstream sleeve and the downstream sleeve, to an operating state, in which the backup assembly is sealingly connected to the upstream sleeve and to the downstream sleeve.

2. The compensator according to claim 1, wherein the backup assembly is suitable for going from the rest state to the operating state after a maintenance operation done in situ, during which the upstream sleeve and the downstream sleeve are intended to remain sealingly connected respectively to the upstream pipe and to the downstream pipe.

3. The compensator according to claim 1, wherein, in the rest state, the backup assembly is sealingly connected to any single one of the upstream sleeve and the downstream sleeve.

4. The compensator according to claim 1, wherein, between the rest state and the operating state of the backup assembly, the backup bellows occupies two separate positions relative to the upstream sleeve and the downstream sleeve.

5. The compensator according to claim 1, wherein backup bellows is suitable for experiencing a plastic deformation by extension during the passage of the backup assembly from the rest state to the operating state.

6. The compensator according to claim 5, further comprising at least one connection point making it possible to connect one or several mechanical devices to the compensator, the mechanical devices being intended to perform the plastic deformation of the backup bellows.

7. The compensator according to claim 6, wherein the connection point is positioned on the backup bellows.

8. The compensator according to claim 1, wherein the backup assembly comprises at least one moving element, the moving element being movable between a first position relative to the upstream and downstream sleeves in the rest state, and a second position, occupied in the operating state and in which the moving element connects the upstream sleeve and the downstream sleeve.

9. The compensator according to claim 8, wherein the moving element is telescopic.

10. The compensator according to claim 1, wherein it comprises at least one device suitable for circulating a gas in a volume located between the bellows and the backup assembly, the circulation of the gas being intended to be done during the passage from the rest state to the operating state.

11. The compensator according to claim 1, wherein it comprises a device suitable for performing a sealing test in a volume located between the bellows and the backup assembly, the sealing test being intended to be done after going from the rest state to the operating state.

12. A maintenance method for maintaining a compensator according to claim 1, comprising at least one operation for connecting the backup assembly in a sealed manner to the upstream sleeve and to the downstream sleeve, the operation being done in situ without disconnecting the upstream sleeve and the downstream sleeve respectively from the upstream pipe and the downstream pipe.

13. The method according to claim 12, wherein the backup bellows is placed instead and in place of the bellows after the latter is deposited.

14. The method according to claim 12, wherein the second bellows is plastically deformed by extension during the passage of the backup assembly from the rest state to the operating state in order to connect the backup assembly sealingly to the upstream sleeve and to the downstream sleeve.

15. The method according to claim 12, wherein a gas circulates in a volume located between the bellows and the backup assembly during the passage from the rest state to the operating state and/or next, in order to perform one or several of the following functions:
purge of the volume,
discharge of dangerous gases that may be found in the volume,
inerting the volume,
limitation of the intake of process fluid in the volume, and
cooling parts delimiting the volume, the parts being able to heat up during the passage from the rest state to the operating state.
